(19) United States
(12) Patent Application Publication
(10) Pub. No.: US 2013/0004127 A1
(43) Pub. Date: Jan. 3, 2013

(54) ACTIVE OPTICAL CABLE (AOC) HAVING A PLASTIC OPTICAL PORT THAT ATTACHES TO AN END OF AN OPTICAL FIBER CABLE OF THE AOC, AND A METHOD OF ASSEMBLING THE AOC

(75) Inventor: Laurence R. McColloch, Santa Clara, CA (US)

(73) Assignee: AVAGO TECHNOLOGIES FIBER IP (SINGAPORE) PTE. LTD., SINGAPORE (SG)

(21) Appl. No.: 13/171,260

(22) Filed: Jun. 28, 2011

(51) Int. Cl. G02B 6/36; B23P 11/00

(52) U.S. Cl. 385/78; 29/428

(57) ABSTRACT

An AOC is provided that has an integrally-formed plastic optical port configured to be directly attached to an end of an optical fiber cable of the AOC without the need for an optical connector. The plastic optical port has an opening formed therein for receiving the end of the optical fiber cable. The AOC connector includes a plurality of electrical leads having proximal ends that are anchored in the plastic optical port and distal ends that extend away from the port. At least one optoelectronic device and at least one IC chip are mounted on one or more of the proximal ends of one or more of the leads. Bond wires electrically interconnect the optoelectronic device, the IC chip and one or more of the other leads. The optoelectronic device, the IC chip and the bond wires are encapsulated in the plastic optical port.

### TECHNICAL FIELD OF THE INVENTION

The invention relates to active optical cables (AOCs). More particularly, the invention relates to an AOC having a plastic optical port configured to attach to an end of an optical fiber cable of the AOC without the need for an optical connector.

### BACKGROUND OF THE INVENTION

An active optical cable is an optical fiber cable that is terminated on one or both ends with an AOC connector that contains an optical transceiver. The AOC connector has an AOC connector housing that is typically configured to be received within an opening formed in a receptacle. The AOC connector typically includes an optical connector and a housing, which are mechanically coupled to each other by mechanical coupling features. The optical connector is permanently attached on one side thereof to the end of the optical fiber. The housing typically has a latch thereon that interlocks with latching features on the receptacle to secure the AOC connector to the receptacle. The receptacle may be, for example, an opening formed in a cage. The latch of the housing is typically operable by a user to be placed in a delatching position to enable the user to disconnect the AOC connector from the receptacle.

The housing of the AOC connector includes electrical circuitry that is connected to the optical transceiver of the AOC connector and to electrical circuitry of the receptacle to which the AOC is connected. In the transmit direction, the electrical circuitry of the AOC delivers an electrical drive signal to an electrical-to-optical (EO) conversion device of the optical transceiver, which converts the electrical signal into an optical signal. The EO conversion device is typically a laser diode or a light emitting diode (LED). The optical signal is then coupled by an optical subassembly (OSA) of the optical connector of the AOC into an end of the optical fiber cable of the AOC. In the receive direction, an optical signal passing out of the end of the optical fiber cable is coupled by the OSA onto an optical-to-electrical (OE) conversion device, such as a photodiode, which converts the optical signal into an electrical signal. The electrical circuitry of the AOC then passes the electrical signal to the electrical circuitry of the receptacle.

FIG. 1 illustrates a top perspective view of a known Quad Small Form-Factor Pluggable (QSFP) AOC 2 currently used in the optical communications industry. An optical fiber cable 3 of the QSFP AOC 2 includes a plurality of transmit optical fibers (not shown for purposes of clarity) and a plurality of receive optical fibers (not shown for purposes of clarity). The cable 3 has an optical connector 3a secured to an end thereof, which, in turn, is secured to an AOC connector 4 of the AOC 2. The AOC connector 4 has an AOC connector housing 5. The aforementioned optical transceiver module (not shown for purposes of clarity) is housed within the AOC connector housing 5. The AOC connector housing 5 includes a first housing portion 5a and a second housing portion 5b, which are connected together by fastening elements (not shown for purposes of clarity). The first and second portions 5a and 5b of the housing 5 are typically made of metal, such as cast aluminum, cast zinc, or a cast zinc alloy.

A delatch device 6 of the AOC connector 4 allows the housing 5 to be delatched from a cage (not shown for purposes of clarity) to enable the housing 5 to be removed from the cage. A pull tab 7 is connected on its proximal end 7a to the delatch device 6. When a user pulls on the distal end 7b of the pull tab 7 in the direction indicated by arrow 8, slider portions 6a and 6b of the delatch device 6 move to a limited extent in the direction indicated by arrow 8 (only slider portion 6a can be seen in FIG. 1). This movement of the slider portions 6a and 6b causes outwardly curved ends 6a′ and 6b′ of the slider portions 6a and 6b, respectively, to press against respective catch features on the cage (not shown for purposes of clarity) to allow the connector housing 5 to be retracted from the cage.

The majority of AOCs currently used in the optical communications industry have configurations that are similar to that of the QSFP AOC 2 shown in FIG. 1, although other types of AOCs having other form factors are also used in the industry. In QSFP AOCs of the type shown in FIG. 1, the optical transceiver module housed in the housing 5 typically includes parallel arrays of electrical-to-optical (EO) conversion elements (e.g., lasers or light-emitting diodes (LEDs)), parallel arrays of optical-to-electrical (OE) conversion elements (e.g., photodiodes), and parallel laser driver and receiver integrated circuit (IC) chips. These parallel components are mounted on an upper surface of a printed circuit board (PCB) 9.

One disadvantage of AOCs of the type described above is that they use optical connectors. These optical connectors often have relatively large form factors. For example, the optical connector may be a larger version of the well known LC connector. Such optical connectors are relatively expensive to produce and consume a relatively large amount of space. Consequently, the optical connector increases the overall form factor of the AOC connector. In addition, the use of such optical connectors in AOCs tends to increase the overall cost of AOCs.

A need exists for an AOC that does not include an optical connector, that has a relatively small form factor, and that has an overall cost that is less than that of known AOCs that are currently available in the market.

### SUMMARY OF THE INVENTION

The invention is directed to an AOC connector, an AOC that incorporates the connector and a method of assembling the AOC. The AOC connector comprises an integrally-formed plastic optical port, a plurality of electrically-conductive leads, at least one optoelectronic device, at least one integrated circuit (IC) chip, and at least first and second electrically-conductive bond wires. The plastic optical port has at least a front side and a back side. The front side has an opening formed therein for receiving an end of an optical fiber cable. Each lead has a proximal end that is encapsulated in the plastic optical port and a distal end that extends from the back side of the plastic optical port. The optoelectronic device is secured to the proximal end of one of the leads and encapsulated in the plastic optical port. The IC chip is secured to the proximal end of one of the leads and encapsulated in the plastic optical port. The first bond wire interconnects the optoelectronic device and the IC chip. The second bond wire interconnects at least one of the optoelectronic device and the IC chip and one or more of the leads. The first and second bond wires are encapsulated in the plastic optical port.

The AOC includes the AOC connector attached to an end of an optical fiber cable. The end of the optical fiber cable is inserted into the opening formed in the front side of the plastic optical port and secured thereto by an adhesive material.

The method comprises providing the AOC, providing the optical fiber cable having first and second ends, placing an adhesive material on at least one of the opening formed in the front side of the plastic optical port and the first end of the optical fiber cable, and inserting the first end of the optical fiber cable into the opening. The adhesive material secures the first end of the optical fiber cable to the opening to thereby fixedly secure the first end of the optical fiber cable to the plastic optical port.

These and other features and advantages of the invention will become apparent from the following description, drawings and claims.

### BRIEF DESCRIPTION OF THE DRAWINGS

FIG. 1 illustrates a top perspective view of a known Quad Small Form-Factor Pluggable (QSFP) AOC currently used in the optical communications industry.

FIG. 2 illustrates a bottom perspective view of an AOC in accordance with an illustrative embodiment.

FIG. 3 illustrates a top perspective view of the AOC shown in FIG. 2.

FIG. 4 illustrates a top plan view of the AOC shown in FIGS. 2 and 3.

FIG. 5 illustrates a bottom plan view of the AOC shown in FIGS. 2-4.

FIG. 6 illustrates a left side plan view of the AOC shown in FIGS. 2-5.

FIG. 7 illustrates a right side plan view of the AOC shown in FIGS. 2-6.

FIG. 8 illustrates a top perspective view of an optical communications system that incorporates multiple instances of the AOC shown in FIGS. 2-7.

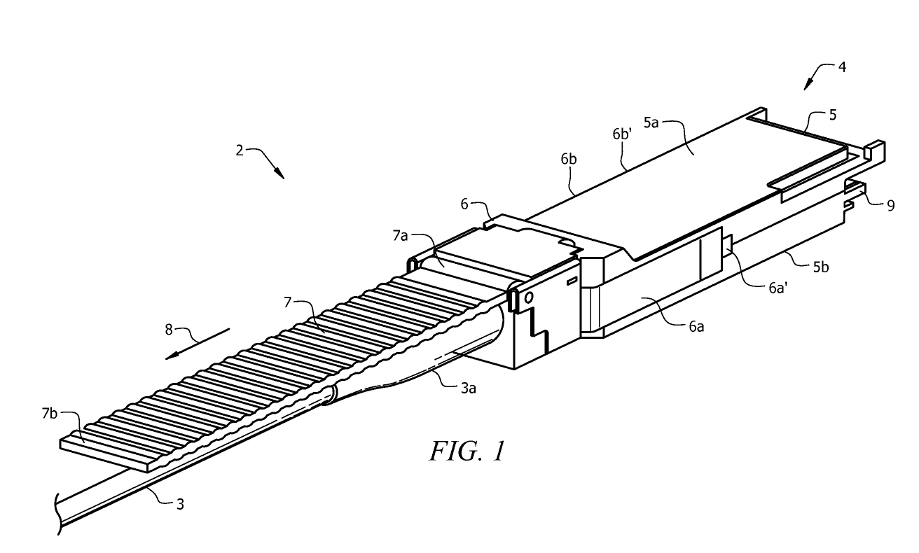

### DETAILED DESCRIPTION OF AN EXEMPLARY EMBODIMENT

The invention is directed to an AOC having an AOC connector that comprises a plastic optical port configured to be directly attached to an end of an optical fiber cable of the AOC without the need for an optical connector. The plastic optical port is an integrally-formed plastic part having an opening formed therein for receiving the end of the optical fiber cable. The AOC connector includes a plurality of electrical leads having proximal ends that are anchored in the plastic optical port. The leads have distal ends that extend away from the port and that are disposed for connection to external electrical circuitry of an external receptacle. At least one optoelectronic device and at least one IC chip are mounted on one or more of the proximal ends of one or more of the leads. The optoelectronic device may be an OE conversion device, such as a photodiode, or it may be an EO conversion device, such as a laser diode or LED. Bond wires electrically interconnect the optoelectronic device(s), the IC chip(s) and one or more of the other leads. The optoelectronic device(s), the IC chip(s) and the bond wires are encapsulated in the plastic optical port. The plastic optical port has a relatively small form factor compared to the form factors of known AOC connectors and can be manufactured at relatively low costs compared to known AOC connectors.

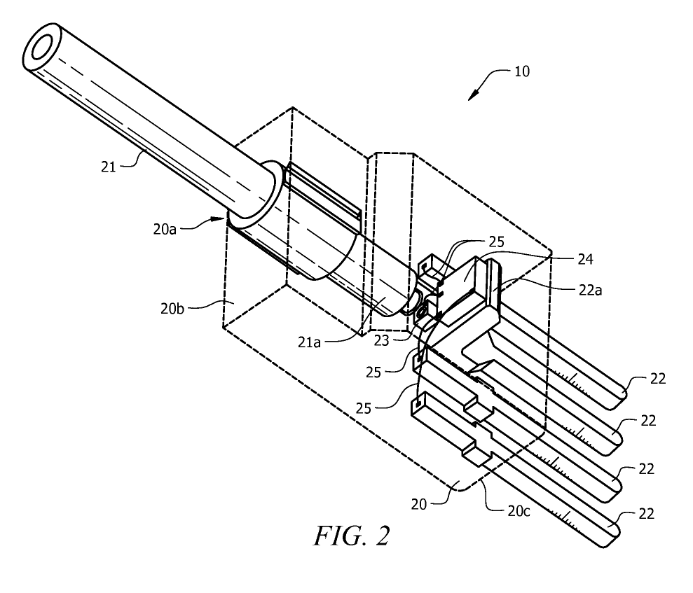

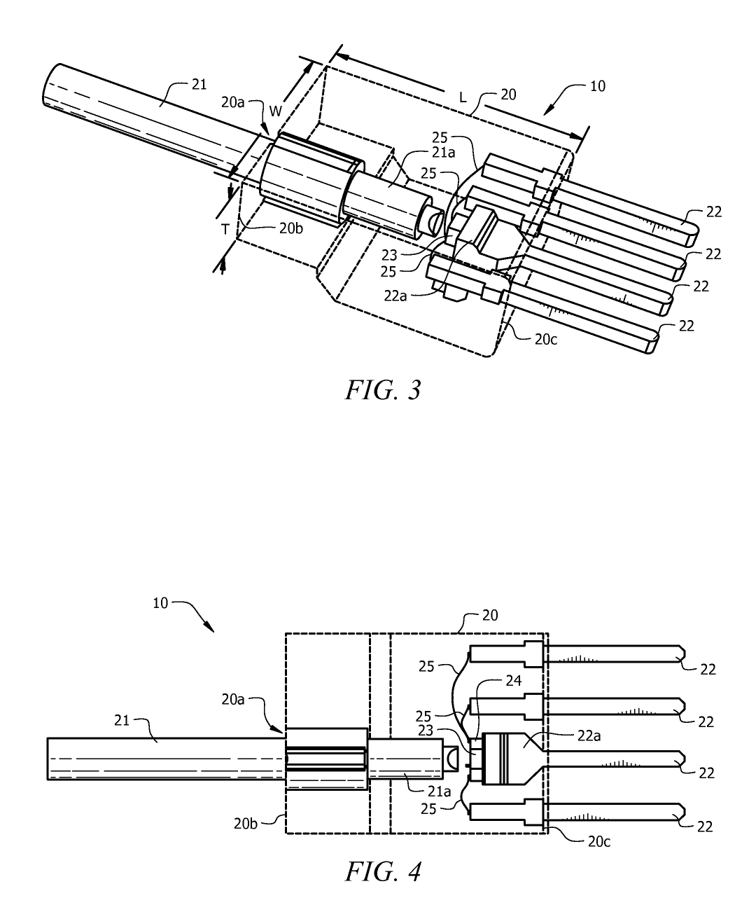

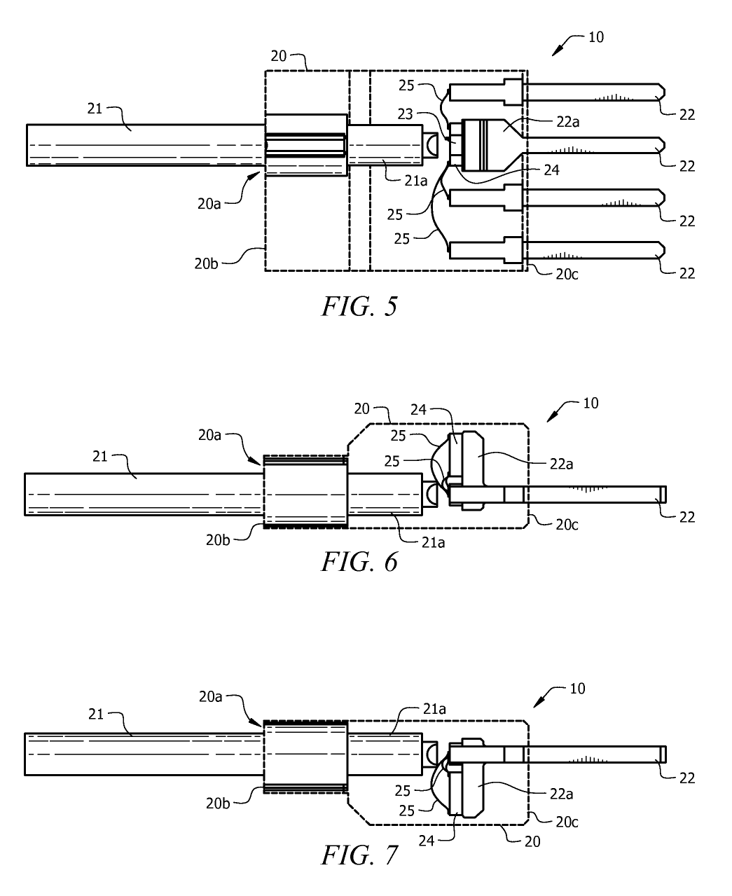

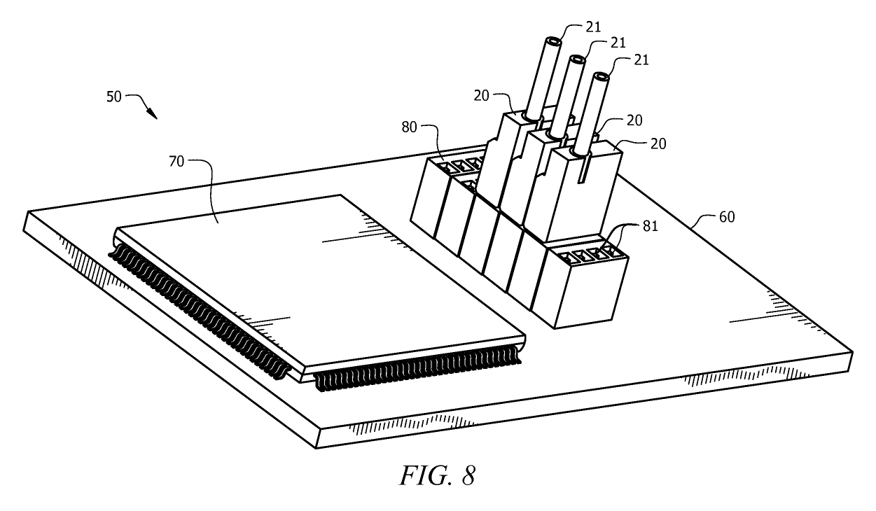

An illustrative, or exemplary, embodiment of the AOC will now be described with reference to FIGS. 2-7. Like reference numerals in FIGS. 2-7 represent like components, elements or features. FIG. 2 illustrates a bottom perspective view of an AOC 10 in accordance with an illustrative embodiment. FIG. 3 illustrates a top perspective view of the AOC 10. FIG. 4 illustrates a top plan view of the AOC 10. FIG. 5 illustrates a bottom plan view of the AOC 10. FIG. 6 illustrates a left side plan view of the AOC 10. FIG. 7 illustrates a right side plan view of the AOC 10.

The AOC 10 comprises a plastic optical port 20, an optical fiber cable 21, a plurality of electrically-conductive leads 22, an optoelectronic device 23, an IC chip 24, and a plurality of bond wires 25. The plastic optical port 20 has an opening 20a formed in a front side 20b thereof. Proximal ends of the leads 22 are anchored in the plastic optical port 20. Distal ends of the leads 22 extend away from a back side 20c of the plastic optical port 20. One of the proximal ends 22a of one of the leads 22 is shaped into a mounting surface. The optoelectronic device 23 and the IC chip 24 are mounted on the mounting surface of the proximal end 22a. One of the bond wires 25 interconnects the optoelectronic device 23 and the IC chip 24. The other bond wires 25 interconnect the IC chip 24 with the proximal ends of the other leads 22.

An end 21a of an optical fiber (not shown) of the optical fiber cable 21 is disposed in close proximity to the optoelectronic device 23. If the optoelectronic device 21 is a laser diode or an LED, light produced by the laser diode or LED is coupled into the end 21a of the optical fiber for transmission over the optical fiber cable 21. Electrical signals applied to one or more of the distal ends of one or more of the leads 22 are received in the IC chip 24 and used by the IC chip 24 to produce electrical drive signals that drive the laser diode or LED. Typically, the opposite end of the optical fiber cable 21 has an AOC connector attached to it that is identical to AOC connector 10 except that it has a photodiode or other OE conversion device. If the optoelectronic device 23 is a photodiode or other OE conversion device, the IC chip 24 will typically be a receiver chip that processes electrical signals produced by the photodiode or other OE conversion device. In the latter case, electrical data signals recovered by the IC chip 24 are output on one or more of the leads 22. In either case, no optics system is needed for coupling light between the end 21a of the optical fiber cable 21 and the optoelectronic device 23. It should be noted, however, that other configurations of the AOC connector 10 may include some type of optics system (e.g., lenses and/or reflectors) for coupling light between the end 21a of the optical fiber cable 21 and the optoelectronic device 23.

The end of the optical fiber cable 21 is directly attached to the opening 20a formed in the plastic optical port 20 by an adhesive material such as, for example, an epoxy that is transparent to an operating wavelength of the optoelectronic device 21. This direct-attachment configuration of the AOC connector 10 eliminates the need for an optical connector, which allows the AOC connector 10 to have a smaller form factor and to be manufactured at relatively low cost. The plastic optical port 20 typically was a width, W, of about 3 to 7 millimeters (mm), a thickness, T, of about 1 to 4 mm, and a length, L, of about 4 to 8 mm. In the illustrative embodiment shown in FIGS. 2-7, the plastic optical port 20 has a width, W, of about 5 mm, a thickness, T, of about 2.5 mm and a length, T, of about 6 mm. This is a relatively small form factor for an AOC connector. There are several advantages to the small form factor of the AOC connector 10, including, for example, reduced costs and reduced area consumption.

The plastic optical port 20 is typically formed by using a known cast molding process during which a liquid plastic material is poured into a mold having the desired shape and having the proximal ends of the leads 22, the optoelectronic device 23, the IC chip 24, and the bond wires 25 disposed therein. The liquid plastic, commonly epoxy, is then cured to cause it to harden around the proximal ends of the leads 22, the optoelectronic device 23, the IC chip 24, and the bond wires 25. The plastic optical port 20 having the leads 22, the optoelectronic device 23, the IC chip 24, and the bond wires 25 encapsulated therein is then removed from the mold. An alternative to using the known cast molding process is to use a known epoxy transfer process to form the plastic optical port 20. Because such processes are well known, a detailed description of these processes will not be provided herein in the interest of brevity.

Typically, after the AOC connector 10 has been manufactured, it will be shipped to a customer unattached to the optical fiber cable 21. The customer will then place an adhesive material on the end 21a of the optical fiber cable 21 and insert it into the opening 20a. As indicated above, the adhesive material may be, for example, epoxy. Prior to inserting the end 21a of the optical fiber cable 21 into the opening 20a, the jacket of the cable 21 is cut to expose the end of the fiber. When the adhesive material hardens about the end 21a of the optical fiber cable 21, it fixedly secures the end 21a of the optical fiber cable 21 to the plastic optical port 20. The adhesive material is generally of a similar index of refraction as that of the fiber so that there is no lens effect or bending of the light passing between the end of the fiber and the optoelectronic device 23. As indicated above, the adhesive material is transparent to the operating wavelength of the optoelectronic device 23.

FIG. 8 illustrates a top perspective view of an optical communications system 50 that incorporates multiple instances of the AOC 10 shown in FIGS. 2-7. Like reference numerals in FIGS. 2-8 represent like components, elements or features. The system 50 includes a printed circuit board (PCB) 60, an IC chip 70, a plurality of sockets 80, and a plurality of the plastic optical ports 20 plugged into the respective sockets 80. Because of the relatively small thickness, T, of the plastic optical ports 20, they can be disposed in the respective sockets 80 in a side-by-side relationship that consumes very little space in the system 50. The sockets 80 may be, for example, standard 4-pin 0.050 inch sockets. The leads 22 (FIGS. 2-7) of each AOC connector 10 are in contact with respective pins 81 of the respective sockets 80.

It should be noted that the invention has been described with reference to illustrative embodiments and that the invention is not limited to these embodiments. Those skilled in the art will understand the manner in which modifications can be made to the illustrative embodiments and that all such modifications are within the scope of the invention. For example, although the plastic optical port 20 has been described as having a particular configuration, persons skilled in the art will understand that the configuration may be modified while still achieving the goals of the invention. The number of leads 22 and their shapes may also be modified without deviating from the scope of the invention. These and other modifications may be made to the embodiments described herein and all such modifications are also within the scope of the invention, as will be understood by persons skilled in the art.

What is claimed is:

1. An active optical cable (AOC) connector for use with an AOC, the AOC connector comprising:
an integrally-formed plastic optical port having at least a front side and a back side, the front side having an opening formed therein for receiving an end of an optical fiber cable;
a plurality of electrically-conductive leads, each lead having a proximal end that is encapsulated in the plastic optical port and a distal end that extends from the back side of the plastic optical port;
at least one optoelectronic device secured to the proximal end of one of the leads and encapsulated in the plastic optical port;
at least one integrated circuit (IC) chip secured to the proximal end of one of the leads and encapsulated in the plastic optical port; and
at least first and second electrically-conductive bond wires, the first bond wire interconnecting the optoelectronic device and the IC chip, the second bond wire interconnecting at least one of the optoelectronic device and the IC chip and one or more of the leads, the first and second bond wires being encapsulated in the plastic optical port.

2. The AOC connector of claim 1, wherein the plastic optical port has a width, W, of about 3 to 7 millimeters (mm).

3. The AOC connector of claim 2, wherein the plastic optical port has a thickness, T, of about 1 to 4 mm.

4. The AOC connector of claim 3, wherein the plastic optical port has a length, L, of about 4 to 8 mm.

5. The AOC connector of claim 1, wherein the plastic optical port has a width, W, of about 5 millimeters (mm).

6. The AOC connector of claim 5, wherein the plastic optical port has a thickness, T, of about 2.5 mm.

7. The AOC connector of claim 6, wherein the plastic optical port has a length, L, of about 6 mm.

8. The AOC connector of claim 1, wherein the opening formed in the front side of the plastic optical port is generally cylindrical in shape to accommodate an end of a generally cylindrically-shaped optical fiber cable, and wherein the optoelectronic device and the IC chip are mounted on the same proximal end of the same lead, and wherein the optoelectronic device is disposed adjacent an end of the opening formed in the front side of the plastic optical port to allow light to be coupled between the optoelectronic device and an end of an optical fiber of the optical fiber cable.

9. The AOC connector of claim 8, wherein the AOC connector has four electrically-conductive leads.

10. An active optical cable (AOC) comprising:
an integrally-formed optical fiber cable having a first end and a second end; and
an AOC connector comprising:
a plastic optical port having at least a front side and a back side, the front side having an opening formed therein for receiving an end of an optical fiber cable, the first end of the optical fiber cable being disposed within the opening and secured thereto by an adhesive material;
a plurality of electrically-conductive leads, each lead having a proximal end that is encapsulated in the plastic optical port and a distal end that extends from the back side of the plastic optical port;
at least one optoelectronic device secured to the proximal end of one of the leads and encapsulated in the plastic optical port;
at least one integrated circuit (IC) chip secured to the proximal end of one of the leads and encapsulated in the plastic optical port; and
at least first and second electrically-conductive bond wires, the first bond wire interconnecting the optoelectronic device and the IC chip, the second bond wire interconnecting at least one of the optoelectronic device and the IC chip and one or more of the leads, the first and second bond wires being encapsulated in the plastic optical port.

11. The AOC of claim 10, wherein the plastic optical port has a width, W, of about 3 to 7 millimeters (mm).

12. The AOC of claim 11, wherein the plastic optical port has a thickness, T, of about 1 to 4 mm.

13. The AOC of claim 12, wherein the plastic optical port has a length, L, of about 4 to 8 mm.

14. The AOC of claim 10, wherein the plastic optical port has a width, W, of about 5 millimeters (mm).

15. The AOC of claim 14, wherein the plastic optical port has a thickness, T, of about 2.5 mm.

16. The AOC of claim 15, wherein the plastic optical port has a length, L, of about 6 mm.

17. The AOC of claim 10, wherein the opening formed in the front side of the plastic optical port is generally cylindrical in shape to accommodate an end of a generally cylindrically-shaped optical fiber cable, and wherein the optoelectronic device and the IC chip are mounted on the same proximal end of the same lead, and wherein the optoelectronic device is disposed adjacent an end of the opening formed in the front side of the plastic optical port to allow light to be coupled between the optoelectronic device and an end of an optical fiber of the optical fiber cable.

18. The AOC of claim 17, wherein the AOC connector has four electrically-conductive leads.

19. A method for assembling an active optical cable (AOC), the method comprising:
providing an AOC connector comprising:
an integrally-formed plastic optical port having at least a front side and a back side, the front side having an opening formed therein for receiving an end of an optical fiber cable;
a plurality of electrically-conductive leads, each lead having a proximal end that is encapsulated in the plastic optical port and a distal end that extends from the back side of the plastic optical port;
at least one optoelectronic device secured to the proximal end of one of the leads and encapsulated in the plastic optical port;
at least one integrated circuit (IC) chip secured to the proximal end of one of the leads and encapsulated in the plastic optical port; and
at least first and second electrically-conductive bond wires, the first bond wire interconnecting the optoelectronic device and the IC chip, the second bond wire interconnecting at least one of the optoelectronic device and the IC chip and one or more of the leads, the first and second bond wires being encapsulated in the plastic optical port;
providing an optical fiber cable having a first end and a second end;
placing an adhesive material on at least one of the opening formed in the front side of the plastic optical port and the first end of the optical fiber cable; and
inserting the first end of the optical fiber cable into the opening, and wherein the adhesive material secures the first end of the optical fiber cable to the opening to fixedly secure the first end of the optical fiber cable to the plastic optical port.

20. The AOC of claim 19, wherein the plastic optical port has a width, W, of about 3 to 7 millimeters (mm).

21. The AOC of claim 20, wherein the plastic optical port has a thickness, T, of about 1 to 4 mm.

22. The AOC of claim 21, wherein the plastic optical port has a length, L, of about 4 to 8 mm.

23. The AOC of claim 19, wherein the plastic optical port has a width, W, of about 5 millimeters (mm).

24. The AOC of claim 23, wherein the plastic optical port has a thickness, T, of about 2.5 mm.

25. The AOC of claim 24, wherein the plastic optical port has a length, L, of about 6 mm.

26. The AOC of claim 19, wherein the opening formed in the front side of the plastic optical port is generally cylindrical in shape to accommodate an end of a generally cylindrically-shaped optical fiber cable, and wherein the optoelectronic device and the IC chip are mounted on the same proximal end of the same lead, and wherein the optoelectronic device is disposed adjacent an end of the opening formed in the front side of the plastic optical port to allow light to be coupled between the optoelectronic device and an end of an optical fiber of the optical fiber cable.

27. The AOC of claim 26, wherein the AOC connector has four electrically-conductive leads.
